(19) United States
(12) Patent Application Publication
(10) Pub. No.: US 2025/0340182 A1
(43) Pub. Date: Nov. 6, 2025

(54) Control of a Motor Vehicle

(71) Applicant: Bayerische Motoren Werke Aktiengesellschaft, Muenchen (DE)

(72) Inventors: Michael FURCHNER, Mering (DE); Marco HIPPLER, Muenchen (DE); Thorsten KNOTT, Tuntenhausen (DE); Daniel KUELZER, Muenchen (DE); Lukas REINHART, Freising (DE)

(21) Appl. No.: 19/192,441

(22) Filed: Apr. 29, 2025

(30) Foreign Application Priority Data
May 6, 2024 (DE) 10 2024 112 711.2

(51) Int. Cl. B60R 25/24; B60R 25/01; B60R 25/20; G07C 9/00; G07C 9/27

(52) U.S. Cl. CPC B60R 25/24; B60R 25/01; B60R 25/2018; G07C 9/00309; G07C 9/27; B60R 2325/205; G07C 2009/00793

(57) ABSTRACT

A method for controlling a motor vehicle secured by a digital vehicle key includes determining that a locking device is set up against the addition of a new digital vehicle key, the locking device denying storage of a newly generated digital vehicle key from a key management. The method further includes detecting a request to unlock the locking device; determining that the request is based on a vehicle key authorized to do so; and disabling the locking device so that a new digital vehicle key that can be used to control the motor vehicle can be added.

### CROSS REFERENCE TO RELATED APPLICATION

This application claims priority under 35 U.S.C. § 119 from German Patent Application No. 10 2024 112 711.2, filed May 6, 2024, the entire disclosure of which is herein expressly incorporated by reference.

### BACKGROUND AND SUMMARY

The present invention relates to the control of a motor vehicle by means of a digital vehicle key. In particular, the invention relates to the addition of a new digital vehicle key.

A motor vehicle comprises a control device, which is set up to control a predetermined security function of the motor vehicle based on a digital vehicle key. A digital vehicle key is stored on the control device, to which an authorization for controlling a security function is assigned. In particular, the security function can comprise a central locking or an immobilizer. Another part of the digital vehicle key can be stored on a user's device. The user can show their digital vehicle key wirelessly at the motor vehicle to control the security function.

A new vehicle key can be added to the system by generating it and digitally signing it using a vehicle key of an owner's digital key. The new vehicle key is then presented to a key management system, which also signs it and stores it accordingly on the motor vehicle. The generated vehicle key can now be presented on the vehicle to control the security function.

To prevent unauthorized generation of a new digital vehicle key for the motor vehicle, the motor vehicle can be triggered no longer to accept a new digital vehicle key. However, no way can be provided to make it possible to add a new vehicle key again later.

An underlying task of the present invention is therefore to provide an improved technology for controlling a locking device against the addition of a digital vehicle key for a motor vehicle. The invention solves this task by means of the objects of the independent Claims. Dependent claims indicate preferred embodiments.

According to a first aspect of the present invention, a method of controlling a motor vehicle secured by means of a digital vehicle key comprises the steps of determining that a locking device is set up against the addition of a new digital vehicle key, wherein the locking device includes a denial of a storage of a newly generated digital vehicle key by a key management system; detecting a request to unlock the locking device; determining that the request is made based on an authorized vehicle key; and disabling the locking device so that a new digital vehicle key which can be used to control the motor vehicle can be added.

The locking device can be selectively set up and disabled to enable or inhibit the addition of a new digital vehicle key to a stock of vehicle keys. The storage includes evaluating an attestation package for a new key that is transmitted from the key management system to the vehicle.

In particular, the digital vehicle key is preferably designed in accordance with the proposals of the Car Connectivity Consortium (CCC) and can be used to control a predetermined security function of the vehicle. The security function can, for example, involve deactivating an immobilizer, starting a drive motor, or unlocking a vehicle door or vehicle flap. Control of the motor vehicle and communication with a device on which a user's digital vehicle key is stored are usually carried out by a control device on board the motor vehicle. To simplify matters, it is also referred to herein that such functions are performed by the motor vehicle.

A technical specification of the underlying technology of the CCC has been published and is regularly updated. The invention is aimed at demonstrating a technical way of disabling an existing locking device for adding a new vehicle key under certain conditions. Preferably, the locking device is disabled in such a way that the locking device can be set up again later. Both processes can also preferably be controlled as often as required.

By setting up the locking device, the motor vehicle can directly prevent a new digital vehicle key from being added to a stock of existing vehicle keys. A vehicle key that is not stored on the vehicle cannot be used to control a security function.

Preferably, the locking device also has the effect that a key management system does not sign a newly generated digital vehicle key and/or does not store it with the motor vehicle. By denying the digital crypto-graphic signature, no valid attestation package can be generated, and without transmitting the attestation package to the motor vehicle, a newly generated digital vehicle key cannot be used there. By controlling both the vehicle and the key management system, the addition can be prevented with increased security in two independent ways.

It is preferred that it is determined that the request is made using a predetermined digital vehicle key. Not all vehicle keys that can be used to control the vehicle are usually authorized to release the locking device. A digital vehicle key with which this is possible can be assigned to a person who has special power of disposal over the vehicle, for example, an owner or an administrative person. The person's authorization to request the disabling of the locking device can be checked based on the vehicle key. For this purpose, the person can present the vehicle key and have it checked in a cryptographic procedure.

A person's digital vehicle key is usually stored on a device. Further preferably, the key is stored there in a secure memory, and the device is set up to require authentication of the person to access the secure memory. In this way, the person, the device, and the key can be linked together.

It is also preferred that the request originates from a predetermined device assigned to the person. The device preferably comprises a mobile device, a smart phone but in other embodiments may also comprise, for example, a smart watch, a smart band, a body-worn device (wearable) or a head-mounted device (head-mounted device).

Setting up the locking device can also be controlled using a digital vehicle key. This vehicle key can also be cryptographically linked to a predetermined device. A person to whom such a vehicle key is assigned may include the same or a different person than the person who can request that the locking device be disabled.

If a request to unlock a locking device set up is detected, first it can be determined that the request is made based on an authorized vehicle key. This enables the locking device set up by the vehicle to be unlocked. The addition of a new digital vehicle key, which can be used to control the vehicle, can then be enabled.

In addition, the locking device set up by the key management system can be unlocked. For this purpose, a message can be transmitted from the motor vehicle to the key management system, so that the locking device is unlocked by the key management system. The message can include a corresponding request. The message or request is also preferably crypto-graphically secured, so that the key management system can only be controlled by the motor vehicle to set up or disable a locking device. In particular, the motor vehicle can authenticate itself to the key management system based on a cryptographic key.

It is preferred that the request for unlock the locking device involves direct interaction with the motor vehicle. The interaction can include a physical actuation of a control element of the motor vehicle. This can ensure that the locking device can only be unlocked by a person who already has access to the motor vehicle. It can also be determined that a user device by means of which the unlocking of the locking device is controlled is within a predetermined maximum distance from the motor vehicle.

To interact with the motor vehicle, it may be sufficient to use a conventional vehicle key to open or activate the motor vehicle. Alternatively, the motor vehicle can be activated using a digital vehicle key. It may also be possible to set up a locking device without direct interaction with the motor vehicle.

Preferably, the motor vehicle is controlled not to accept a digital vehicle key that was generated after a locking device was set up and before a locking device was unlocked. This prevents a digital key that was signed by a key management system from automatically becoming valid while the vehicle is already locked if the locking device on the vehicle is later unlocked again.

In a particularly preferred embodiment, the key management system, and the motor vehicle each have a counter. The counter can operate in any units and increments and is set up to only increase a counter reading and never decrease it. In particular, the counter is incremented when a locking device is set up and optionally when the locking device is unlocked. The key management system also preferably assigns a current counter reading of its counter to a vehicle key to be stored. The motor vehicle can deny a storage of a vehicle key whose assigned counter reading is lower than the current counter reading of the motor vehicle.

In this way, it can be considered that the generation or unlocking of a locking device at the key management system may be delayed with respect to the generation or unlocking of a locking device by the motor vehicle. Preferably, the counter of the key management system is synchronized with the counter of the motor vehicle when a locking device is unlocked.

It is also preferred that resetting the motor vehicle to the default settings unlocks a set locking device. This relates to a complete reset of the motor vehicle to a state that can be equivalent to the delivery of the motor vehicle. Different security measures, user settings, learned values or collected data can each be reset to predetermined values. This means that the motor vehicle can be put to a new use in an emergency, even if it is no longer possible to unlock a set locking device using a digital vehicle key provided for this purpose.

A digital vehicle key for the motor vehicle can be assigned to a group. Different groups can be provided, and a key can also be assigned to several groups. An authorized vehicle key for a request described herein can be recognized based on the assignment to a predetermined group. For example, a group of administrators can be provided who can set up or unlock a locking device. Alternatively, a first group of keys can be provided that can set a locking device and a second group that can unlock a locking device.

According to a further aspect of the present invention, a control device for a motor vehicle comprises a user interface for detecting a request to disable a locking device against the addition of a new digital vehicle key which can be used to control the motor vehicle; and a processing device. The processing device is set up to determine that the request is based on an authorized digital vehicle key; and in this case to disable an existing locking device so that a deposit of a newly generated digital vehicle key is accepted by a key management system.

In addition, the control device can transmit a message to the key management system to request the disabling of a further locking device by the key management system.

The processing device is preferably set up to partially or completely execute a method described herein. For this purpose, the processing device may be electronic and comprise, for example, an integrated circuit, a programmable logic device or a programmable microcomputer. The method can be implemented in the form of a configuration or as a computer program product with program code means for the processing device. The configuration or computer program product may be stored on a computer-readable data carrier. Features or advantages of the method can be transferred to the device or vice versa.

According to yet another embodiment of the present invention, a motor vehicle comprises a control device described herein. The motor vehicle preferably comprises a motorcycle or a passenger vehicle; in further embodiments, the motor vehicle may also comprise, for example, a truck or a bus.

According to a further aspect of the present invention, a key management system for a digital vehicle key for a motor vehicle is set up to receive a request to release a locking device against an addition of a new digital vehicle key, which can be used to control the motor vehicle; to determine that the request originates from the motor vehicle; and to disable an existing locking device. A locking device set up on the key management system preferably causes the key management system to deny a signing of a new digital vehicle key or to process a request for the provision of the vehicle key and/or of a validation package.

According to yet another aspect of the present invention, a system comprises a key management system described herein and at least one motor vehicle described herein.

The invention is now described more precisely in respect of the appended drawings, in which the following are illustrated:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a system;

FIG. 2 is a flowchart of a method; and

FIG. 3 is a flowchart of a further method.

### DETAILED DESCRIPTION OF THE DRAWINGS

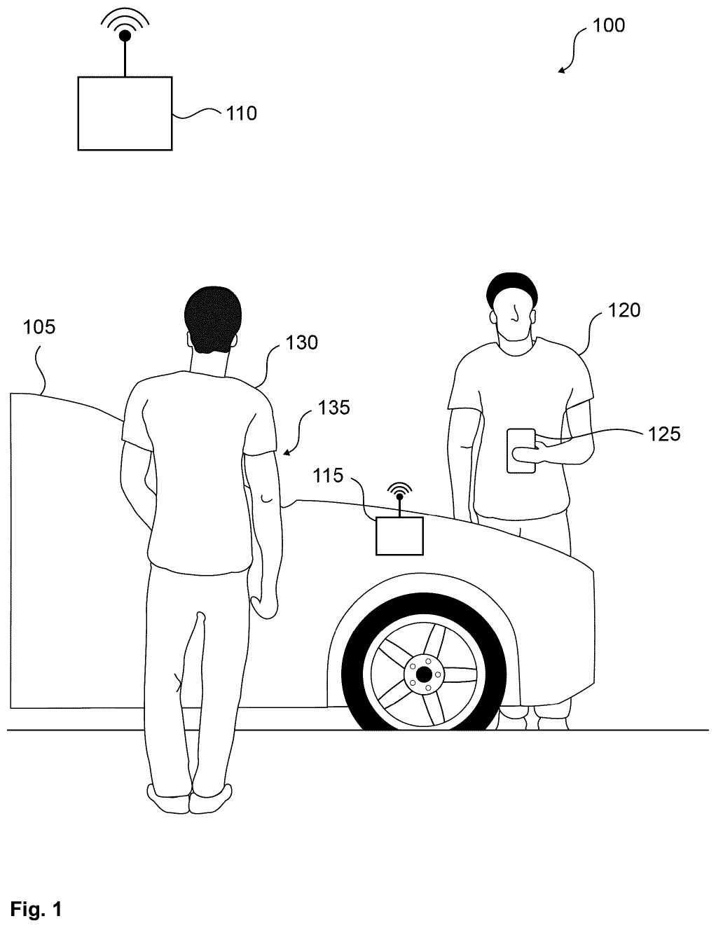

FIG. 1 shows a system 100 with a motor vehicle 105 and a key management system 110. The motor vehicle 105 comprises a control device 115, which is set up to control a predetermined function of the motor vehicle 105, in particular a security function, based on a digital vehicle key. The security function can comprise, for example, an unlocking of a vehicle door or vehicle flap of the motor vehicle 105, a deactivation of an immobilizer or an activation of a drive motor.

The underlying concept of the digital vehicle key herein preferably follows the proposals of Car Connectivity Consortium (CCC). Put simply, a specific digital vehicle key is assigned to a first person 120 and usually stored on a first mobile device 125, which is assigned to the first person 120. The digital vehicle key is additionally stored on the control device 115 in the motor vehicle 105. The control of a security function of the motor vehicle 105 requires a cryptographic exchange between the control device 115 and the mobile device 125. Preferably, an asymmetric cryptographic method is used to authenticate one of the communication partners. The digital vehicle key may comprise a private part, which is stored on the mobile device 125, and a public part, which is stored on the control device 115.

Conversely, a public key of the control device 115 can be known by the first mobile device 125, the corresponding private key of which is only known by the control device 115. In a so-called standard transaction, mutual authentication of the first mobile device 125 and the control device 115 can be carried out. To make their digital key accessible in the first mobile device 125, the person 120 can authenticate themselves to the first mobile device 125 beforehand, for example, by presenting a biometric feature or by entering a predetermined secret.

A new digital vehicle key can be generated and assigned to a second person 130, who is assigned for this purpose to a second mobile device 135. For example, it can be assumed that the first person 120 is an owner of the motor vehicle 105 and that the digital vehicle key assigned to them authorizes them to issue or sign a new vehicle key. The second person 120 is usually referred to as friend.

The generation process can comprise that the key management system 110 signs a newly generated digital vehicle key digitally and generates an attestation package, which comprises the signed key, and stores this attestation package at the motor vehicle 105 or the control device 115.

It is proposed to selectively inhibit or unlock again the addition of a new digital vehicle key on a stock of valid digital vehicle keys, which can be used to control the motor vehicle 105. It is especially preferred that a locking device for preventing the addition of a new vehicle key is set up or unlocked primarily by the motor vehicle 105 or the control device 115 as well as optionally also by the key management system 110.

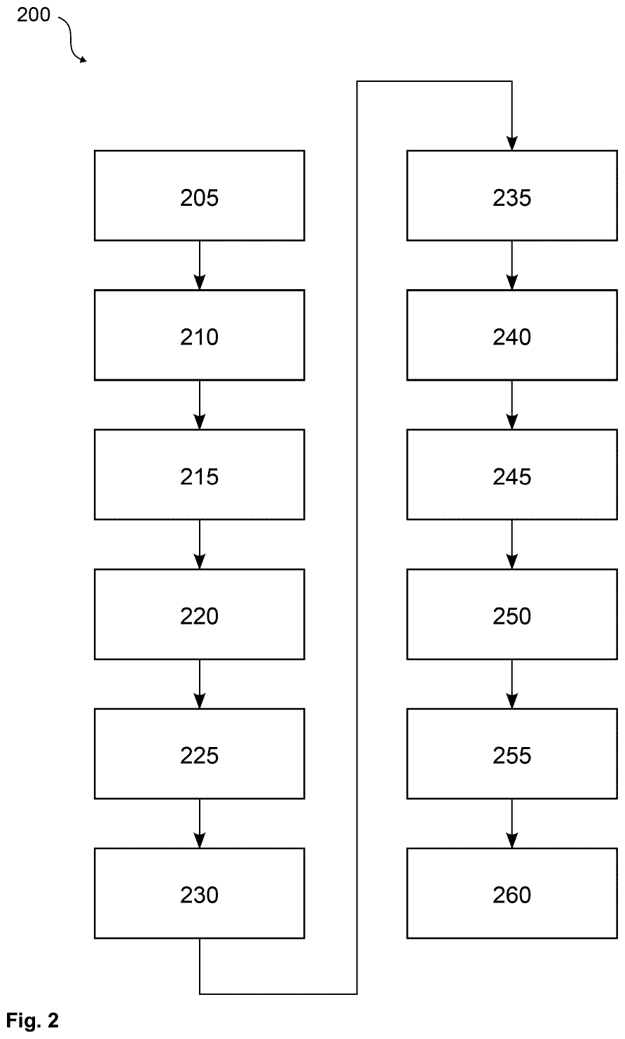

FIG. 2 shows a flowchart of a method 200 for exiting or participating in a key generation process. An exiting corresponds to a setting up of at least one locking device; and a participation to the disabling of all locking devices.

In step 205, it is assumed that the motor vehicle 105 is in an initial state regarding its control by means of a digital vehicle key. This state can be assumed when the motor vehicle 105 is transferred by the manufacturer to its first owner.

In step 210, an owner key can be generated. This is a digital vehicle key, which is usually assigned the authorization to generate or sign a newly generated vehicle key. In other words, the first person 120 as owner with the vehicle key assigned to them can generate or cryptographically sign digital further vehicle keys.

In step 215, further keys can possibly be generated, for example, for the second person 130. If the stock of digital vehicle keys that can be used for controlling the motor vehicle 105 corresponds to the ideas of the first person 120, this person can make a request to exit from the addition of a new vehicle key. For this purpose, the first person 120 can transmit a corresponding message to the control device 115 with the help of their first mobile device 125 and the digital vehicle key stored on it.

In step 225, it can be checked by the control device 115 whether a received request comprises an authorization to exit. For this purpose, it can be checked whether this authorization is assigned to the digital vehicle key based on which the request was generated. Authorizations of a digital vehicle key are generally defined before the vehicle key is generated or cryptographically signed.

In step 230, it can be checked whether there is at least one digital vehicle key in a stock of valid digital vehicle keys for the motor vehicle 105, based on which a subsequent participation in the addition of a new digital vehicle key can be controlled. In other words, it can be checked before the setting up of a locking device against the addition of a new digital vehicle key for the motor vehicle 105 whether predetermined preconditions are fulfilled to unlock the locking device again later.

In step 235, a corresponding locking device can be set up on the motor vehicle 105 or the control device 115. In particular, the lock can prevent an attestation package for a newly generated digital vehicle key for the motor vehicle 105 from being accepted or the digital vehicle key contained therein from being stored.

In step 240, a message from the motor vehicle 105 to the key management system can be transmitted to trigger this in return also to set up a locking device against the addition of a digital vehicle key for the motor vehicle 105. This locking device can bring about that a request for signing a digital vehicle key (key signing request) or a request for key tracking (key tracking request) for the motor vehicle 105 is not fulfilled. Moreover, it can be prevented that an information packet regarding a newly generated digital vehicle key is transmitted to the motor vehicle 105 or the control device 115.

The addition of a new digital vehicle key in the stock of valid vehicle keys for the motor vehicle 105 is already prevented when only one of the locking devices is set up. However, existing digital vehicle keys of the stock can continue to be used. Optionally, a digital vehicle key of the stock can also be declared invalid while one of the locking devices is active. It should preferably be ensured here that always at least one digital vehicle key is still in the stock which can be used to unlock the locking device.

In step 245, a request to disable the locking device against the addition of a new vehicle key for the motor vehicle 105 can be received. The request is preferably generated by using a digital vehicle key and an authentication is made preferably based on the vehicle key. It can also be checked whether the vehicle key was used by means of an associated device 125. Moreover, it can be determined whether an authorization of the key to disable the locking device is valid.

If all checks are successful, in a step 250, the locking device can be unlocked by the motor vehicle 105 or by the control device 115. In step 255, a request to unlock a locking device can be transmitted from the control device 115 to the key management system 110.

The key management system 110 can define an authenticity of the transmitter and the existence of a corresponding authorization and then release a locally existing locking device regarding the motor vehicle 105.

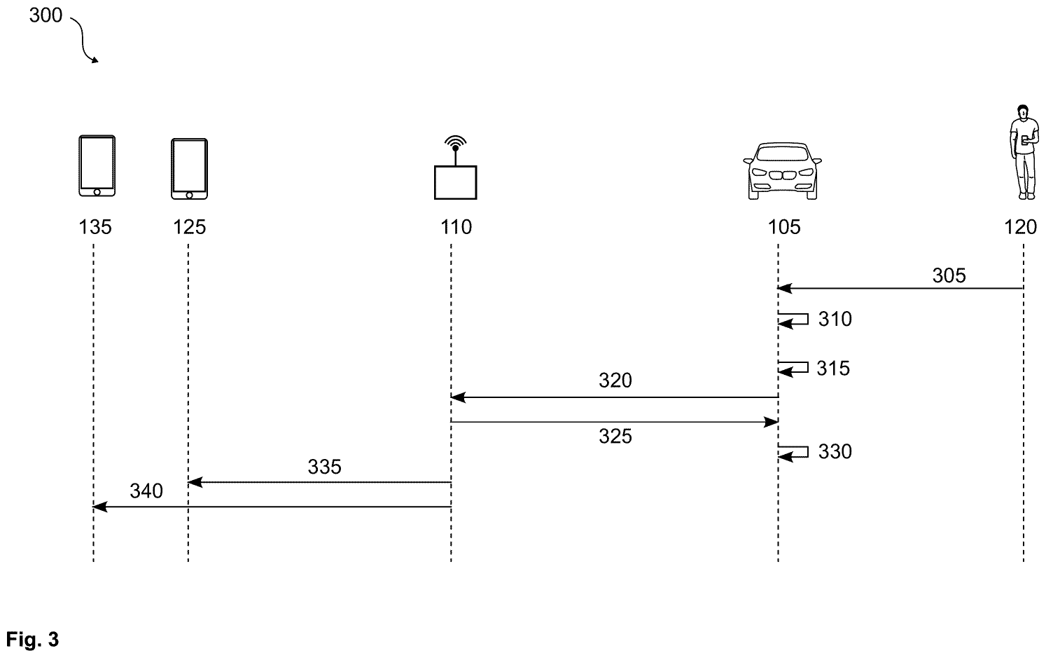

In step 260, a synchronization between the control device 115 and the key management system 110 can take place, which is explained in more detail below with reference to FIG. 3. This is a possible method for ensuring that a digital vehicle key, which was generated after the control device 115 set up the locking device but before the key management system 110 set up the locking device, becomes valid after the control device 115 unlocks the locking device.

FIG. 3 shows a flowchart of a further method 300. In a first step 305, a request for participating in the addition of a new digital vehicle key for the motor vehicle 105 is detected. This step can correspond to step 220 of the method 200 of FIG. 2. The request usually originates from the first person 120 and is detected by the motor vehicle 105 or its control device 115.

In step 310 it is verified whether the digital vehicle key, based on which the request was generated, is assigned to an authorization to carry out the request. This step can correspond to step 225 from FIG. 2.

If the check is positive, the motor vehicle 105 can be controlled such that an addition of a new digital vehicle key is no longer accepted in a step 315, which can correspond to the step 235 of FIG. 2.

At the control device 115 a first counter and at the key management system 110 a second counter is provided. These counters are initially synchronized so that they both have the same counter readings. However, with the setting up of a locking device, the respective counter reading increases.

In step 320, a request to set up a locking device can be transmitted from the motor vehicle 105 to the key management system 110. The request can comprise the increased counter reading of the first counter of the motor vehicle 105 or of the control device 115.

In step 325, the key management system 110 for its part can set up a locking device. Moreover, it can correspondingly increase the counter reading of the second counter and transmit a confirmation to the motor vehicle 105, which indicates that the key management system 110 is now also locked. The increased counter reading of the second counter can be appended to the confirmation.

In step 330, the control device 115 can evaluate the confirmation and determine that both counters are now synchronized with one another and show the same counter reading.

In step 335, the key management system 110 can transmit a message to the first mobile device 125 of the first person 120, which points out that the addition of a new vehicle key in a stock of functioning vehicle keys for the motor vehicle 105 is locked. A corresponding notification can be transmitted to a second mobile device 135 of the second person 130 in a step 340. It is assumed in this regard that the first person 120 has the state of an owner of the motor vehicle 105 and the second person 130 does not. Any number of owner 120 and/or non-owners 130 can be provided for.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SYMBOLS

100 System
105 Motor vehicle
110 Key management system
115 Control device
120 First person (owner)
125 First mobile device
130 Second person (friend)
135 Second mobile device
200 Method
205 Motor vehicle new
210 Generating an owner key
215 Possibly generating a further key
220 Detecting request to exit
225 Request justified?
230 Vehicle key for participating exists?
235 Locking the motor vehicle
240 Locking key management system
245 Detecting request for participating, checking authorization
250 Approving the motor vehicle
255 Approving the key management system
260 Synchronizing
300 Method
305 Detecting request for participating
310 Checking authorization
315 Locking the motor vehicle
320 Locking request to key management system
325 Confirmation
330 Counters synchronized
335 Notification
340 Notification

What is claimed is:

1. A method for controlling a motor vehicle, which is secured by a digital vehicle key, the method comprising:
determining that a locking device is set up against addition of a new digital vehicle key, wherein the locking device denies storage of a newly generated digital vehicle key via a key management system;
detecting a request to unlock the locking device;
determining that the request is made based on a digital vehicle key authorized to do so; and
disabling the locking device, so that the new digital vehicle key can be added for controlling the motor vehicle.

2. The method according to claim 1, wherein the request is made using a predetermined digital vehicle key.

3. The method according to claim 2, wherein it is determined that the request originates from a predetermined device assigned to the digital vehicle key.

4. The method according to claim 1, wherein the locking device causes the key management system to not sign the newly generated digital vehicle key; and
wherein the disabling of the locking device comprises transmitting a message from the motor vehicle to the key management system, so that the locking device is disabled by the key management system.

5. The method according to claim 2, wherein the locking device causes the key management system to not sign the newly generated digital vehicle key; and
wherein the disabling of the locking device comprises transmitting a message from the motor vehicle to the key management system, so that the locking device is disabled by the key management system.

6. The method according to claim 1, wherein the request to unlock the locking device requires a direct interaction with the motor vehicle.

7. The method according to claim 2, wherein the request to unlock the locking device requires a direct interaction with the motor vehicle.

8. The method according to claim 1, wherein the motor vehicle is controlled to not accept a digital vehicle key that was generated after setting up the locking device and before unlocking the locking device.

9. The method according to claim 2, wherein the motor vehicle is controlled to not accept a digital vehicle key that was generated after setting up the locking device and before unlocking the locking device.

10. The method according to claim 6, wherein the key management system and the motor vehicle each carry a counter that is incremented when the locking device is set up;
wherein the key management system assigns a current counter reading of its counter to a digital vehicle key to be stored; and
wherein the motor vehicle denies storage of a digital vehicle key whose assigned counter reading is less than the current counter reading of the motor vehicle.

11. The method according to claim 1, wherein a resetting of the motor vehicle to manufacturer settings unlocks a set locking device.

12. The method according to claim 2, wherein a resetting of the motor vehicle to manufacturer settings unlocks a set locking device.

13. The method according to claim 3, wherein a resetting of the motor vehicle to manufacturer settings unlocks a set locking device.

14. The method according to claim 1, wherein the digital vehicle key of the motor vehicle is assignable to a group; and
wherein an authorized vehicle key is recognized based on an assignment to a predetermined group.

15. The method according to claim 2, wherein the digital vehicle key of the motor vehicle is assignable to a group; and
wherein an authorized vehicle key is recognized based on an assignment to a predetermined group.

16. A device for controlling a motor vehicle, the device comprising:
a user interface for detecting a request to disable a locking device against addition of a new digital vehicle key, which can be used for controlling the motor vehicle;
a processing device, which is configured to determine that the request is made based on a digital vehicle key authorized to make the request, and to disable an existing locking device, so that storage of a newly generated digital vehicle key is accepted by a key management system.

17. A motor vehicle comprising a device according to claim 16.

18. A key management system for a digital vehicle key for a motor vehicle, wherein the key management system is configured to receive a request to release a locking device against addition of a new digital vehicle key, which can be used for controlling the motor vehicle, determine that the request originates from the motor vehicle, and disable an existing locking device.

19. A system comprising:
a key management system according to claim 18; and
a motor vehicle including a device for controlling the motor vehicle, wherein the device includes:
a user interface for detecting a request to disable a locking device against addition of a new digital vehicle key, which can be used for controlling the motor vehicle;
a processing device, which is configured to determine that the request is made based on a digital vehicle key authorized to make the request, and to disable an existing locking device, so that storage of a newly generated digital vehicle key is accepted by a key management system.
